(19) United States
(12) Patent Application Publication
(10) Pub. No.: US 2024/0039182 A1
(43) Pub. Date: Feb. 1, 2024

(54) TERMINAL BLOCK

(71) Applicant: SUMITOMO WIRING SYSTEMS, LTD., Mie (JP)

(72) Inventor: Koichi YOKOTANI, Mie (JP)

(21) Appl. No.: 18/265,397

(22) PCT Filed: Dec. 17, 2021
(86) PCT No.: PCT/JP2021/046753

§ 371 Date: Jun. 5, 2023

(30) Foreign Application Priority Data
Dec. 22, 2020 (JP) 2020-212408

(51) Int. Cl. H01R 9/24; H01R 4/30

(52) U.S. Cl. CPC H01R 9/24; H01R 4/30

(57) ABSTRACT

A terminal block (10) according to one aspect of the present disclosure is provided with a connection terminal (20) having a first surface (22a) formed to face a mating terminal (110), a second surface (22b) located opposite to the first surface (22a) and an insertion hole (22c) penetrating through the first surface (22a) and the second surface (22b), a bolt (150) being inserted through the insertion hole (22c), the connection terminal being electrically connected to the mating terminal (110), a nut (30) facing the second surface (22b) in an axial direction of the insertion hole (22c) and fastenable to the bolt (150), a housing (40) for holding the connection terminal (20) and the nut (30), and a resilient member (70) provided to surround a part surrounding the insertion hole (22c), out of the first surface (22a).

### TECHNICAL FIELD

The present disclosure relates to a terminal block.

### BACKGROUND

Patent Document 1 discloses a terminal block to be mounted on a device for vehicle. The terminal block is provided with a connection terminal to be electrically connected to a mating terminal and a nut provided opposite to the mating terminal across the connection terminal.

Each of the mating terminal and the connection terminal includes an insertion hole. A bolt inserted through the insertion hole of the mating terminal and the insertion hole of the connection terminal is screwed into a nut, whereby the mating terminal and the connection terminal are fastened by the bolt.

### PRIOR ART DOCUMENT

### Patent Document

Patent Document 1: JP 2015-095356 A

### SUMMARY OF THE INVENTION

### Problems to be Solved

At the time of connecting the mating terminal and the connection terminal, a gap due to manufacturing tolerances and assembly tolerances may be formed between the mating terminal and the connection terminal. If the mating terminal and the connection terminal are fastened by the bolt in a state where such a gap is present, the mating terminal may be deformed in a direction toward the connection terminal to fill up this gap.

The present disclosure aims to provide a terminal block capable of suppressing the deformation of a mating terminal.

### Means to Solve the Problem

The present disclosure is directed to a terminal block with a connection terminal having a first surface formed to face a mating terminal, a second surface located opposite to the first surface and an insertion hole penetrating through the first and second surfaces, a bolt being inserted through the insertion hole, the connection terminal being electrically connected to the mating terminal, a nut facing the second surface in an axial direction of the insertion hole, the nut being fastenable to the bolt, a housing for holding the connection terminal and the nut, and a resilient member provided to surround a part surrounding the insertion hole, out of the first surface.

### Effect of the Invention

According to the present disclosure, the deformation of a mating terminal can be suppressed.

### BRIEF DESCRIPTION OF THE DRAWINGS

FIG. 1 is an exploded perspective view showing a terminal block of one embodiment and a connector.

FIG. 2 is a section showing the terminal block of the embodiment and the connector.

FIG. 3 is an exploded perspective view showing the terminal block of the embodiment.

### DETAILED DESCRIPTION TO EXECUTE THE INVENTION

### Description of Embodiments of Present Disclosure

First, embodiments of the present disclosure are listed and described.

[1] The terminal block of the present disclosure is provided with a connection terminal having a first surface formed to face a mating terminal, a second surface located opposite to the first surface and an insertion hole penetrating through the first and second surfaces, a bolt being inserted through the insertion hole, the connection terminal being electrically connected to the mating terminal, a nut facing the second surface in an axial direction of the insertion hole, the nut being fastenable to the bolt, a housing for holding the connection terminal and the nut, and a resilient member provided to surround a part surrounding the insertion hole, out of the first surface.

According to this configuration, with the mating terminal and the connection terminal connected, the resilient member is interposed between the mating terminal and the connection terminal. In this way, in fastening the mating terminal and the connection terminal by the bolt, the resilient member is deformed, thereby absorbing tolerances between the mating terminal and the connection terminal. Therefore, the deformation of the mating terminal can be suppressed.

[2] Preferably, the resilient member includes a first part to be provided in the part surrounding the insertion hole, out of the first surface, a second part to be provided in a part surrounding the insertion hole, out of the second surface, and a tubular third part to be inserted into the insertion hole, the third part coupling the first and second parts.

According to this configuration, the escape of the resilient member from the insertion hole of the connection terminal can be suppressed by the engagement of the second part coupled to the first part via the third part with the second surface.

[3] Preferably, the nut includes a body portion having an internal thread fastenable to the bolt and a projecting portion configured to project from the body portion toward the second surface and contact the second surface.

If the resilient member includes the second part, the nut and the connection terminal may become less likely to contact each other due to the presence of the second part between the connection terminal and the nut.

In this respect, according to the above configuration, since the nut includes the projecting portion, a contact state of the nut and the connection terminal can be ensured.

[4] Preferably, the resilient member is electrically conductive.

According to this configuration, an electrically conductive path passing through the mating terminal, the resilient member and the connection terminal is formed. In this way, a cross-sectional area of the electrically conductive path is easily secured as compared to the case where the resilient member is electrically insulating.

[5] Preferably, the terminal block is provided with a plurality of the connection terminals to be respectively connected to a plurality of the mating terminals, a plurality of the nuts, and a plurality of the resilient members.

In the terminal block provided with the plurality of connection terminals, an interval between the mating terminal and the connection terminal differs for each corresponding pair of the mating terminal and the connection terminal. Also in this configuration, tolerances between each mating terminal and each connection terminal are absorbed as described above. Therefore, the deformation of the plurality of mating terminals can be suppressed.

[6] Preferably, a high voltage is applied to the connection terminal.

If a high voltage is applied to the connection terminal, a thickness of each of the mating terminal and the connection terminal is desirably increased to secure cross-sectional areas of the mating terminal and the connection terminal serving as the electrically conductive path. However, the mating terminal becomes more difficult to deform as the thickness thereof increases.

According to the above configuration, even if the thickness of the mating terminal is large and the mating terminal is difficult to deform, the tolerances between the mating terminal and the connection terminal can be suitably absorbed by the resilient member. Therefore, the mating terminal and the connection terminal, to which a high voltage is applied, can be suitably connected.

### Details of Embodiment of Present Disclosure

A specific example of a terminal block of the present disclosure is described below with reference to the drawings. For the convenience of description, some components may be shown in an exaggerated or simplified manner in each drawing. Further, a dimension ratio of each part may be different in each figure. Note that the present disclosure is not limited to these illustrations, but is represented by claims and intended to include all changes in the scope of claims and in the meaning and scope of equivalents. “Parallel” and “orthogonal” in this specification mean not only strictly parallel and orthogonal, but also substantially parallel and orthogonal within a range in which functions and effects in this embodiment are achieved.

(Configuration of Terminal Block 10)

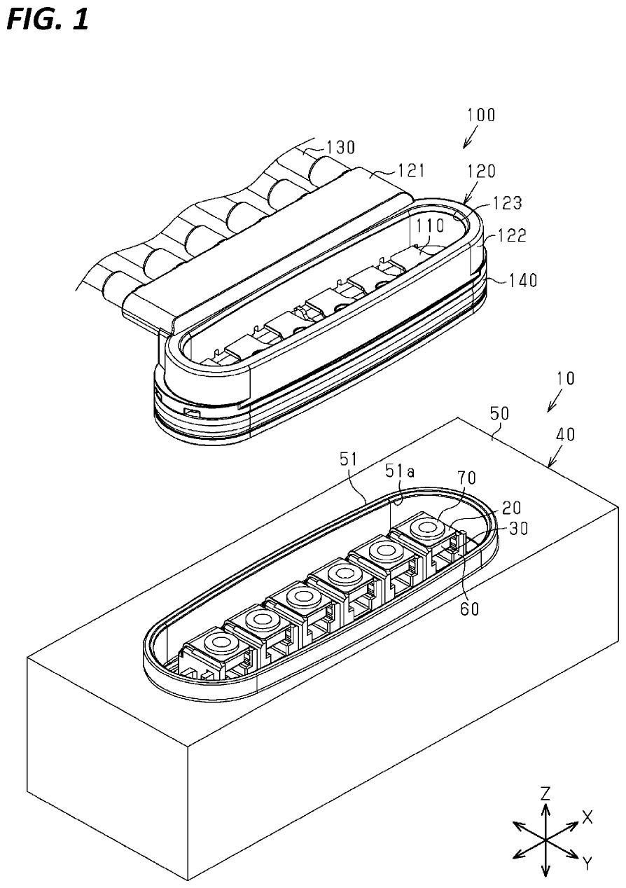

As shown in FIG. 1, the terminal block 10 is, for example, mounted on a case of an unillustrated device for vehicle. The terminal block 10 is, for example, mounted on a case of a motor. A connector 100 provided on one end of a wiring harness is, for example, connected to the terminal block 10. The terminal block 10 extends in a direction orthogonal to a connecting direction of the terminal block 10 and the connector 100 as a whole.

Note that, out of XYZ axes in each drawing, the X axis represents a length direction of the terminal block 10, the Y axis represents a width direction of the terminal block 10 orthogonal to the X axis and the Z axis represents a height direction of the terminal block 10 orthogonal to both the X and Y axes. In the following description, for the sake of convenience, a direction along the X axis is referred to as an X-axis direction, a direction along the Y axis is referred to as a Y-axis direction and a direction along the Z axis is referred to as a Z-axis direction.

The terminal block 10 is provided with a plurality of connection terminals 20 arranged in parallel in the X-axis direction, a plurality of nuts 30, a housing 40 for holding the plurality of connection terminals 20 and the plurality of nuts 30, and a plurality of resilient members 70. The terminal block 10 is, for example, provided with six connection terminals 20, six nuts 30 and six resilient members 70.

(Configuration of Connector 100)

The connector 100 is provided with a plurality of mating terminals 110 arranged in parallel in the X-axis direction and a connector housing 120 made of resin for holding the plurality of mating terminals 110. The connector 100 includes, for example, six mating terminals 110. The mating terminals 110 and the connector housing 120 are, for example, integrated by insert molding.

The connector housing 120 includes a holding portion 121 for holding the plurality of mating terminals 110 and a tubular portion 122 having a tubular shape.

The holding portion 121 projects toward one side in the Y-axis direction from the tubular portion 122.

The tubular portion 122 includes an opening 123 penetrating through the tubular portion 122 in the Z-axis direction. The opening 123 has an oval shape long in the X-axis direction. An annular sealing member 140 for sealing between the tubular portion 122 and the housing 40 to be described later is provided on the outer peripheral surface of the tubular portion 122.

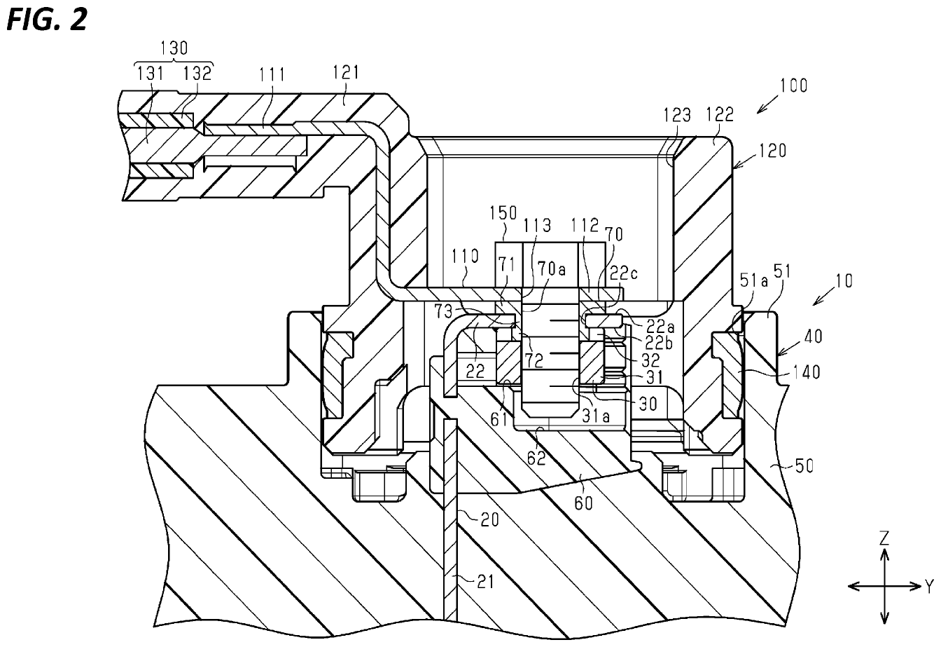

As shown in FIG. 2, the plurality of mating terminals 110 project into the opening 123 from the holding portion 121.

The mating terminal 110 is, for example, in the form of a flat plate bent into a crank shape. The mating terminal 110 includes a wire connecting portion 111 and a terminal connecting portion 112. The mating terminal 110 is a single component in which the wire connecting portion 111 and the terminal connecting portion 112 are integrally formed. The mating terminal 110 is, for example, formed of a metal material such as copper, copper alloy, aluminum, aluminum alloy or stainless steel.

A wire 130 is electrically connected to the wire connecting portion 111. Here, the wire 130 includes a core wire 131 and an insulation coating 132 covering the outer periphery of the core wire 131. The core wire 131 is exposed from the insulation coating 132 in an end part of the wire 130. The core wire 131 exposed from the insulation coating 132 is connected to the wire connecting portion 111.

The wire connecting portion 111 and a part of the wire 130 are held in the holding portion 121.

The terminal connecting portion 112 is located inside the opening 123. The terminal connecting portion 112 is provided with an insertion hole 113, into which a bolt 150 made of metal is inserted. The insertion hole 123 penetrates through the terminal connecting portion 112 in the Z-axis direction. The insertion hole 113 has a circular shape.

(Configuration of Connection Terminal 20)

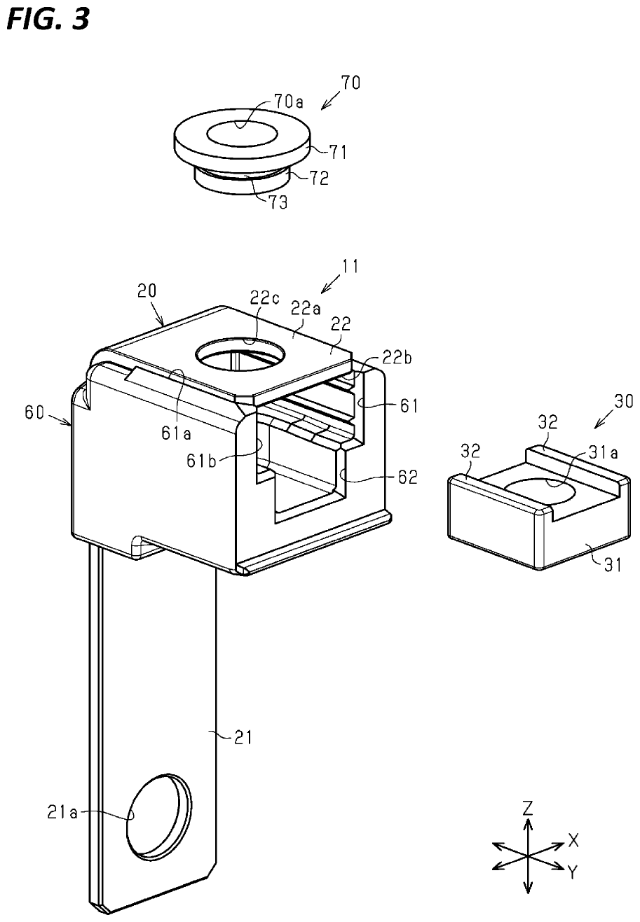

As shown in FIGS. 2 and 3, the connection terminal 20 is in the form of a flat plate. The connection terminal 20 includes a first extending portion 21 extending in the Z-axis direction and a second extending portion 22 bent from an end part of the first extending portion 21 and extending toward one side in the Y-axis direction. The connection terminal 20 is, for example, L-shaped as a whole. The connection terminal 20 is, for example, formed of a metal material such as copper, copper alloy, aluminum, aluminum alloy or stainless steel.

A high voltage is applied to the connection terminal 20 of this embodiment. The “high voltage” in this specification is a rated voltage of a high-voltage wire specified in “JASO D624(2015)”. This rated voltage is higher than 30 V and equal to or lower than 600 V in the case of an alternating-current voltage and is higher than 60 V and equal to or lower than 750V in the case of a direct-current voltage.

As shown in FIG. 3, an insertion hole 21a, into which an unillustrated bolt is inserted, is provided in an end part of the first extending portion 21 opposite to the second extending portion 22. The insertion hole 21a penetrates through the first extending portion 21 in a thickness direction, i.e. in the Y-axis direction. The first extending portion 21 is, for example, electrically connected to an unillustrated device terminal provided inside the device by the unillustrated bolt.

As shown in FIGS. 2 and 3, the second extending portion 22 has a first surface 22a formed to face the mating terminal 110, a second surface 22b located opposite to the first surface 22a and an insertion hole 22c penetrating through the first and second surfaces 22a, 22b, a bolt 150 being inserted through the insertion hole 22c.

The first and second surfaces 22a, 22b are located opposite to each other in the Z-axis direction. Each of the first and second surfaces 22a, 22b has, for example, a flat surface orthogonal to the Z-axis direction. The first and second surfaces 22a, 22b are, for example, parallel.

The insertion hole 22c penetrates through the second extending portion 22 in a plate thickness direction, i.e. in the Z-axis direction.

(Configuration of Housing 40)

As shown in FIGS. 1 and 2, the housing 40 includes a housing body 50 and a plurality of holding members 60 for holding the plurality of connection terminals 20 and the plurality of nuts 30. The housing body 50 and the plurality of holding members 60 are, for example, integrally formed of a resin material.

The housing body 50 includes a receptacle 51 projecting toward the connector 100 in the Z-axis direction. The receptacle 51 is provided with an opening 51a having an oval shape long in the X-axis direction. The plurality of connection terminals 20 are exposed from the opening 51a. The tubular portion 122 of the connector 100 is inserted into the receptacle 51 from the Z-axis direction.

As shown in FIG. 3, the holding member 60 is, for example, integrally provided to the connection terminal 20 by insert molding. The holding member 60 holds an end part connected to the second extending portion 22 in the first extending portion 21.

The holding member 60 includes an accommodation recess 61 for accommodating the nut 30. The accommodation recess 61 includes an upper opening 61a open in the same direction as the opening 51a of the receptacle 51 in the Z-axis direction and a side opening 61b open in an extending direction of the second extending portion 22 along the Y-axis direction. The upper opening 61a is covered by the second extending portion 22 of the connection terminal 20. The insertion hole 22c of the connection terminal 20 and the accommodation recess 61 overlap in the Z-axis direction.

The holding member 60 includes an escaping recess 62 for allowing the tip of the bolt 150 inserted through the insertion hole 22c to escape. The escaping recess 62 is provided in a part facing the upper opening 61a of the accommodation recess 61 in the holding member 60. The escaping recess 62 is provided to be continuous with the accommodation recess 61. A width in the X-axis direction of the escaping recess 62 is smaller than that of the accommodation recess 61. The escaping recess 62 is open in the same direction as the side opening 61b of the accommodation recess 61 along the Y-axis direction.

(Configuration of Nut 30)

As shown in FIGS. 2 and 3, the nut 30 is held in the holding member 60 by being press-fit into the accommodation recess 61 through the side opening 61b.

The nut 30 includes a body portion 31 in the form of a rectangular column and two projecting portions 32 configured to project toward the second surface 22b of the connection terminal 20 from the body portion 31. The nut 30 is, for example, formed of a metal material.

The body portion 31 includes an internal thread 31a fastenable to the bolt 150. The internal thread 31a penetrates through the body portion 31 in the Z-axis direction. The nut 30 is so arranged that an axis of the internal thread 31a is coaxial with an axis of the insertion hole 22c of the connection terminal 20.

The body portion 31 is provided at a position separated from the second extending portion 22 of the connection terminal 20 in the Z-axis direction. That is, a gap is provided between the body portion 31 and the second extending portion 22.

The projecting portions 32 project from both ends in the X-axis direction of the body portion 31. The projecting portions 32 project from parts on an outer peripheral side of the internal thread 31a, out of the body portion 31. The two projecting portions 32 extend in the Y-axis direction and are parallel. Each of the projecting portions 32 is in contact with the second surface 22b of the connection terminal 20. A flat surface orthogonal to the Z-axis direction is, for example, formed on the projecting tip of the projecting portion 32. Thus, the projecting portion 32 and the second surface 22b are in surface contact.

(Configuration of Resilient Member 70)

As shown in FIGS. 2 and 3, the resilient member 70 is mounted on the connection terminal 20.

The resilient member 70 includes a first part 71, a second part 72 and a third part 73. The resilient member 70 includes a through hole 70a which penetrates through the first, second and third parts 71, 72 and 73 and through which the bolt 150 is inserted.

The resilient member 70 is, for example, configured to be resiliently deformable by an electrically conductive resin material. The resilient member 70 is, for example, formed of rubber containing an electrically conductive filler such as metal particles or carbon particles.

The first part 71 has a hollow cylindrical shape. The first part 71 is provided in a part surrounding the insertion hole 22c, out of the first surface 22a. A thickness of the first part 71 is set to be larger than a tolerance between the mating terminal 110 and the connection terminal 20.

The second part 72 has a hollow cylindrical shape. The second part 72 is provided in a part surrounding the insertion hole 22c, out of the second surface 22b. The second part 72 is arranged in the gap between the body portion 31 of the nut and the second extending portion 22 of the connection terminal 20. That is, the second part 72 is arranged between the two projecting portions 32.

The third part 73 has a hollow cylindrical shape. The third part 73 is inserted into the insertion hole 22c and couples the inner edges of the first and second parts 71, 72. A length in the Z-axis direction of the third part 73 is equal to a plate thickness of the connection terminal 20, i.e. a depth of the insertion hole 22c.

An outer diameter of the second part 72 is smaller than that of the first part 71. An outer diameter of the third part 73 is smaller than that of the first part 71 and that of the second part 72. The outer diameter of the second part 72 is larger than a diameter of the insertion hole 22c of the connection terminal 20. The outer diameter of the third part 73 is substantially equal to the diameter of the insertion hole 22c.

In mounting the resilient member 70 on the connection terminal 20, the resilient member 70 is inserted into the insertion hole 22c while the second part 72 is resiliently deformed. When passing through the insertion hole 22c, the second part 72 is resiliently restored into an original shape. This causes the second part 72 to be engaged with the second surface 22b of the connection terminal 20. In this way, the resilient member 70 is mounted on the connection terminal 20.

(Manufacturing Method of Terminal Block 10)

As shown in FIG. 3, in the manufacturing of the terminal block 10 of this embodiment, a plurality of primary molded bodies 11, in each of which the connection terminal 20 and the holding member 60 are integrally formed, are first formed. Thereafter, the nuts 30 are press-fit into the accommodation recesses 61 of the holding members 60 and the resilient members 70 are mounted into the insertion holes 22c of the connection terminals 20. Then, the housing body 50 is formed by secondary molding using the plurality of primary molded bodies 11 provided with the nuts 30 and the resilient members 70 as cores. In this way, the plurality of primary molded bodies 11 and the housing body 50 are integrally formed.

In press-fitting the nut 30 into and mounting the resilient member 70 on the primary molded body 11, the resilient member 70 may be mounted on the connection terminal 20 after the nut 30 is press-fit into the holding member 60 or the nut 30 may be press-fit into the holding member 60 after the resilient member 70 is mounted on the connection terminal 20.

Note that, as described above, the second part 72 of the resilient member 70 is arranged between the two projecting portions 32. Thus, the nut 30 can be press-fit into the holding member 60 even in a state where the resilient member 70 is mounted on the connection terminal 20.

Functions of this embodiment are described.

With the mating terminal 110 and the connection terminal 20 connected, the resilient member 70 is interposed between the mating terminal 110 and the connection terminal 20. In this way, in fastening the mating terminal 110 and the connection terminal 20 by the bolt, the resilient member 70 is deformed to absorb tolerances between the mating terminal 110 and the connection terminal 20.

Further, in the terminal block 10 provided with the plurality of connection terminals 20, the interval between the mating terminal 110 and the connection terminal differs for each corresponding pair of the mating terminal 110 and the connection terminal 20. Even in this case, the tolerances between each mating terminal 110 and each connection terminal 20 are absorbed by each resilient member 70.

Effects of this embodiment are described.

(1) The terminal block 10 is provided with the plurality of connection terminals 20, the plurality of nuts 30, the housing 40 and the plurality of resilient members 70. The connection terminal 20 has the first surface 22a formed to face the mating terminal 110, the second surface 22b located opposite to the first surface 22a and the insertion hole 22c penetrating through the first and second surfaces 22a, 22b, the bolt 150 being inserted through the insertion hole 22c. The nut 30 is facing the second surface 22b in the Z-axis direction and fastenable to the bolt 150. The housing 40 holds the plurality of connection terminals 20 and the plurality of nuts 30. The resilient member 70 is provided in the part surrounding the insertion hole 22c, out of the first surface 22a.

According to this configuration, the deformation of the mating terminals 110 can be suppressed since the aforementioned functions are achieved.

(2) The resilient member 70 includes the first part 71 to be provided in the part surrounding the insertion hole 22, out of the first surface 22a, the second part 72 to be provided in the part surrounding the insertion hole 22, out of the second surface 22b, and the tubular third part 73 to be inserted into the insertion hole 22c and coupling the first and second parts 71, 72.

According to this configuration, the second part 72 coupled to the first part 71 via the third part 73 is engaged with the second surface 22b, whereby the escape of the resilient member 70 from the insertion hole 22c of the connection terminal 20 can be suppressed.

(3) The nut 30 includes the body portion 31 having the internal thread 31a fastenable to the bolt 150 and the projecting portions 32 configured to project from the body portion 31 toward the second surface 22b and contact the second surface 22b.

If the resilient member 70 includes the second part 72, the nut 30 and the connection terminal 20 may become less likely to contact each other due to the presence of the second part 72 between the connection terminal 20 and the nut 30.

In this point, since the nut 30 includes the projecting portions 32 according to the above configuration, a contact state of the nut 30 and the connection terminal 20 can be ensured.

(4) The resilient member 70 is electrically conductive.

According to this configuration, an electrically conductive path passing through the mating terminal 110, the resilient member 70 and the connection terminal 20 is formed. In this way, a cross-sectional area of the electrically conductive path is easily ensured as compared to the case where the resilient member 70 is electrically insulating.

(5) A high voltage is applied to the connection terminal 20.

If a high voltage is applied to the connection terminal 20, the thickness of each of the mating terminal 110 and the connection terminal 20 is desirably increased to secure cross-sectional areas of the mating terminal 110 and the connection terminal 20 serving as the electrically conductive path. However, the mating terminal 110 becomes more difficult to deform as the thickness thereof increases.

According to the above configuration, even if the thickness of the mating terminal 110 is large and the mating terminal 110 is difficult to deform, the tolerances between the mating terminal 110 and the connection terminal 20 can be suitably absorbed by the resilient member 70. Therefore, the mating terminal 110 and the connection terminal 20, to which a high voltage is applied, can be suitably connected.

<Modifications>

This embodiment can be modified and carried out as follows. This embodiment and the following modifications can be carried out in combination without technically contradicting each other.
A low voltage may be applied to the connection terminal 20.
The terminal block 10 may be, for example, mounted on a case of a device such as an inverter.
The numbers of the connection terminals 20, the nuts 30 and the resilient members 70 can be changed as appropriate.
The resilient member 70 may be made of electrically conductive elastomer obtained by containing an electrically conductive filler in a resin material.
If the resilient member 70 is electrically conductive, the bolt 150 and the nut 30 made of resin or ceramic can be adopted.
The resilient member 70 may be electrically insulating. Even in such a configuration, since the nut 30 is in contact with the connection terminal 20, an electrically conductive path passing through the mating terminal 110, the bolt 150, the nut 30 and the connection terminal 20 is formed. In this way, the mating terminal 110 and the connection terminal 20 are electrically connected.
The nut 30 may include one projecting portion 32 or include three or more projecting portions 32. Further, the projecting portion 32 may surround the outer periphery of the internal thread 31a over an entire periphery. In this case, the resilient member 70 may be mounted on the connection terminal 20 after the nut 30 is press-fit into the primary molded body 11.
The connection terminal 20 may include an electrically conductive projection configured to project toward the nut 30 and contact the nut 30. The projection can be, for example, mounted on the connection terminal 20 by welding. In this case, the projecting portions 32 can be omitted from the nut 30.
Only the second part 72 or both the second and third parts 72, 73 can be omitted from the resilient member 70. In this configuration, the resilient member 70 is sandwiched between the mating terminal 110 and the connection terminal 20, thereby being fixed between these. Further, in this configuration, the projecting portions 32 can be omitted from the nut 30. In this case, the body portion 31 of the nut 30 contacts the second surface 22b of the connection terminal 20.
The resilient member 70 may include a slit extending over the entire resilient member 70 in the Z-axis direction. In this case, since the resilient member 70 can be reduced in diameter by being resiliently deformed to reduce a width of the slit, an operation of inserting the resilient member 70 into the insertion hole 22c of the connection terminal 20 is facilitated.
The resilient member 70 may be composed of a plurality of divided bodies obtained by dividing the resilient member 70 of the above embodiment along the Z-axis direction. In this case, the operation of inserting the resilient member 70 into the insertion hole 22c of the connection terminal 20 is facilitated.
The first part 71 of the resilient member 70 may be referred to as a compressible flange, a resilient flange or an annular cushion. When the connection terminal 20 and the mating terminal 110 are fastened by the bolt 150 and the nut 30, the first part 71 of the resilient member 70 may be sandwiched in a compressed state between the connection terminal 20 and the mating terminal 110. The resilient rebound of the first part 71 of the resilient member 70 is advantageous in pressing the connection terminal 20 toward the projecting portions 32 of the nut 30 and stabilizing the electrical contact of the connection terminal 20 and the projecting portions 32 of the nut 30 and, eventually, advantageous in stabilizing the electrical contact of the connection terminal and the mating terminal 110.
The resilient member 70 of the embodiment may be referred to as an elastic-flanged bushing or an electrically conductive cylindrical bushing.
The resilient member 70 may have an H-shaped cross-section. The resilient member 70 may be sandwiched between the mating terminal 110 and the first surface 22a of the connection terminal 20, between the bolt 150 and the insertion hole 22c and between the body portion 31 of the nut 30 and the second surface 22b of the connection terminal 20. For example, in the example shown in FIGS. 2 and 3, a vertical cross-section of the resilient member 70, i.e. a cross-section parallel to a center axis (e.g. Z axis) of the resilient member 70, which can be a center axis of the hollow cylindrical second part 72, and including this center axis may be H-shaped. The projection of the resilient member 70 in a direction orthogonal to the center axis (e.g. Z axis) of the resilient member 70 may be H-shaped.
The thickness of the first part 71 of the resilient member 70 may be set to be larger than the gap between the mating terminal 110 and the connection terminal 20 in inserting the tubular portion 122 of the connector 100 into the receptacle 51 of the terminal block 10, i.e. in mounting the connection terminal 100 into the terminal block 10.
The projecting portions 32 of the nut 30 may not be provided in a part facing the side opening 61b, out of the body portion 31 of the nut 30, in press-fitting the nut 30 into the accommodation recess 61.

### LIST OF REFERENCE NUMERALS

10 terminal block
11 primary molded body
20 connection terminal
21 first extending portion
21a insertion hole
22 second extending portion
22a first surface
22b second surface
22c insertion hole
30 nut
31 body portion
31a internal thread
32 projecting portion
40 housing
50 housing body
51 receptacle
51a opening
60 holding member
61 accommodation recess
61a upper opening
61b side opening
62 escaping recess
70 resilient member
70a through hole
71 first part
72 second part
73 third part
100 connector
110 mating terminal
111 wire connecting portion
112 terminal connecting portion
113 insertion hole
120 connector housing
121 holding portion
122 tubular portion
123 opening
130 wire
131 core wire
132 insulation coating
140 sealing member
150 bolt

1. A terminal block, comprising:
a connection terminal having a first surface formed to face a mating terminal, a second surface located opposite to the first surface and an insertion hole penetrating through the first and second surfaces, a bolt being inserted through the insertion hole, the connection terminal being electrically connected to the mating terminal;
a nut facing the second surface in an axial direction of the insertion hole, the nut being fastenable to the bolt;
a housing for holding the connection terminal and the nut; and
a resilient member provided to surround a part surrounding the insertion hole, out of the first surface.

2. The terminal block of claim 1, wherein the resilient member includes a first part to be provided in the part surrounding the insertion hole, out of the first surface, a second part to be provided in a part surrounding the insertion hole, out of the second surface, and a tubular third part to be inserted into the insertion hole, the third part coupling the first and second parts.

3. The terminal block of claim 2, wherein the nut includes a body portion having an internal thread fastenable to the bolt and a projecting portion configured to project from the body portion toward the second surface and contact the second surface.

4. The terminal block of claim 1, wherein the resilient member is electrically conductive.

5. The terminal block of claim 1, comprising:
a plurality of the connection terminals to be respectively connected to a plurality of the mating terminals;
a plurality of the nuts; and
a plurality of the resilient members.

6. The terminal block of claim 1, wherein a high voltage is applied to the connection terminal.
